(19) United States
(12) Patent Application Publication
(10) Pub. No.: US 2009/0001868 A1
(43) Pub. Date: Jan. 1, 2009

(54) Image display device and manufacturing method thereof

(76) Inventors: Tomoki Nakamura, Chiba (JP); Hiroyasu Yanase, Mobara (JP); Toshiaki Kusunoki, Tokorozawa (JP); Etsuko Nishimura, Ota (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/153,482

(22) Filed: May 20, 2008

(30) Foreign Application Priority Data
Jun. 25, 2007 (JP) 2007-166552

(51) Int. Cl. H01J 63/04; H01J 9/24

(52) U.S. Cl. 313/496; 445/24

(57) ABSTRACT

An image display device comprising a back-surface substrate (1) having a plurality of first electrodes (8), an insulating film (14), a plurality of second electrodes (9), and an electron source (10); a front-surface substrate (2) having a fluorescent layer (15), and further having an anode for the application of an acceleration voltage; a frame (3) disposed between the front-surface substrate (2) and the back-surface substrate (1); and a sealing member (5) for sealing the frame (3) and the two substrates in an airtight manner in a sealed area (52). The second electrodes (9) cover the insulating film (14) disposed beneath these second electrodes (9) in at least the sealed area (52), and place the sealing member (5) and the insulating film (14) in a non-contact state.

### CROSS-REFERENCE TO RELATED APPLICATIONS

The present application claims priority from Japanese application JP 2007-166552 filed on Jun. 25, 2007, the content of which is hereby incorporated by reference into this application.

### BACKGROUND OF THE INVENTION

1. Field of the Invention

The present invention relates to a self-luminous flat panel image display device, and more particularly relates to an image display device in which an electron source is arranged in the form of a matrix.

2. Description of the Related Art

Field emission image display devices (FED: field emission displays) and electron emission image display devices utilizing cold cathodes that can be finely integrated are known as one of the self-luminous flat panel displays (FPD) having an electron source that is arranged in the form of a matrix.

Examples of cold cathodes include Spindt electron sources, surface-conductive electron sources, carbon nanotube electron sources, and thin film electron sources such as MIM (metal-insulator-metal) electron sources having a metal-insulator-metal laminated structure, MIS (metal-insulator-semiconductor) electron sources having a metal-insulator-semiconductor laminated structure, metal-insulator-semiconductor-metal electron sources, and the like.

A typical self-luminous FPD comprises a back-surface substrate in which an electron source of the type described above is disposed on an insulating substrate made of a glass plate, a front-surface substrate in which a fluorescent layer and an anode forming an electric field used to direct electrons emitted from the electron source at this fluorescent layer are disposed on an insulating substrate comprising a light-transmitting material that is preferably glass, and a frame which maintains the space between the facing inside parts of the two substrates at a specified gap. A driving circuit is combined with the display panel, which has a construction in which the inner space including the display region formed by both substrates and the frame is kept in a vacuum state.

Furthermore, the back-surface substrate having a plurality of first electrodes which extend in one direction and which are installed side by side in another direction perpendicular to this one direction, an insulating film formed so as to cover these first electrodes, and a plurality of second electrodes which extend in the abovementioned other direction above this insulating film and which are installed parallel to each other in the abovementioned one direction so as to cross the abovementioned first electrodes, with scanning signals being successively applied to these second electrodes. In such a self-luminous FPD, in addition, a construction is used in which electron sources of the abovementioned type are respectively installed in the vicinity of the intersection parts of the second electrodes and the first electrodes; the second electrodes and electron sources are connected by feed electrodes; and a current is supplied to the electron source from the second electrodes.

Furthermore, the respective individual electron sources form pairs with the fluorescent layers corresponding to the respective electron sources, so that unit pixels are constructed. Ordinarily, a single pixel (color pixel) is constructed from unit pixels of three colors, i.e., red (R), green (G), and blue (B). Furthermore, in the case of color pixels, the unit pixels are also called sub-pixels.

In image display devices such as those described above, in addition to the abovementioned constructions, a construction is also used in which a plurality of gap-maintaining members (spacers) are disposed and fastened inside a vacuum region including a display region surrounded by the frame between the back-surface substrate and the front-surface substrate, and the gap between the two substrates is maintained at a specified gap in conjunction with the frame. Such spacers generally comprise a plate-form body composed of an insulating material such as glass, a ceramic, or the like, or a material that has some conductivity, and are ordinarily disposed for a plurality of pixels at a time in positions that do not interfere with the operation of the pixels.

Alternatively, a frame constituting a sealing frame is fastened by a sealing material such as fritted glass or the like to the inside edges of the back-surface substrate and the front-surface substrate, and this fastened part is sealed in an airtight manner to form a sealed region. The vacuum inside the vacuum region including the display region surrounded by both of the substrates and the frame is, for example, approximately 10⁻⁵ to 10⁻⁷ Torr.

Second electrode lead terminals leading to the second electrodes formed on the back-surface substrate, and first electrode lead terminals leading to the first electrodes, are respectively formed passing through the sealed region between the frame and the substrates.

The abovementioned MIM electron sources are disclosed in, for example, Japanese Laid-Open Patent Application No. 2004-363075 and Japanese Laid-Open Patent Application No. 2006-107741. The structure and operation of MIM electron sources are as follows. Specifically, a voltage is applied across an upper electrode and a lower electrode having a structure in which an insulating layer is interposed between the upper electrode and lower electrode, so that electrons in the vicinity of the Fermi level in the lower electrode pass through the barrier by tunneling, and are injected into the conduction band of the insulating layer which is an electron acceleration layer, thus forming hot electrons which flow into the conduction band of the upper electrode. Among these hot electrons, electrons reaching the surface of the upper electrode with an energy equal to or greater than the work function φ of the upper electrode are emitted into a vacuum.

### SUMMARY OF THE INVENTION

A matrix can be formed by arranging such electron sources in a plurality of rows (for example, in the horizontal direction) and a plurality of columns (for example, in the vertical direction), thus constituting an image display device by disposing numerous fluorescent layers arranged in correspondence with the respective electron sources in a vacuum. In cases where an image display is performed in an image display device constructed in this manner, a driving method called line-sequential driving can be used in a standard manner.

This is a method in which a display in each frame is performed for each second electrode (in the horizontal direction) when still images are displayed at the rate of 60 frames per second. Accordingly, electron sources corresponding to the number of first electrodes are all simultaneously operated on the same second electrodes. A current obtained by multiplying the current consumed by the electron sources included in the sub-pixels (sub-pixels forming one color pixel used for full-color display) by the total number of the first electrodes flows to the second electrodes during operation. Since this second electrode current causes a voltage drop along the second electrodes by the wiring resistance, the uniform operation of the electron sources is hindered. In particular, the voltage drop caused by the wiring resistance of the second electrodes is a major problem in producing a large display device.

In order to solve this problem, it is necessary to reduce the wiring resistance of the second electrodes. In the case of thin-film electron sources, it is conceivable that the resistance of the second electrodes feeding the first electrodes or upper electrodes might be lowered. However, in cases where the thickness is increased in order to lower the resistance of the first electrodes, indentations and projections in the wiring become conspicuous. Then problems in reliability occur, e.g., the quality of the electron acceleration layer drops, the second electrodes and the like tend to be cut, and so forth. Accordingly, a method which lowers the resistance of the second electrodes is preferable.

The use of a thick-film material with a small resistivity is effective in lowering the wiring resistance of the second electrodes. Copper (Cu) has a lower resistivity than silver (Ag) Furthermore, copper is inexpensive, and shows a rapid sputtering film formation rate, so that a thick film can easily be formed. Moreover, Cu can form a thick film using plating methods as well. Accordingly, Cu is a material that is appropriate for use as the second electrodes. However, Cu readily oxidizes; for example, in cases where Cu is used in an FPD panel, Cu tends to readily oxidize in the high-temperature sealing process. Accordingly, a conceivable procedure involves Cu being sandwiched above and below by parts made of a metal that is heat-resistant and highly oxidation-resistant. However, when Cu is sandwiched above and below by metals with a high oxidation resistance, although most of the Cu escapes oxidation, the oxidation of the side surfaces of the wiring cannot be prevented. It is desirable that the second electrodes also have a mechanism of self-regulated separation of upper electrodes of electron source pixels. However, as a result of the oxidation of the wiring side surfaces, undercut portions formed by the Cu and the under-layer film may undergo deformation, and the pixel separation characteristics may deteriorate.

Furthermore, in order to lower the wiring resistance of the second electrodes, it is also effective, for example, to use silver (Ag) or gold (Au) electrodes or the like formed by screen printing. Moreover, a structure in which the upper electrodes of the electron source pixels are separated in a self-aligning manner, and a spacer electrode function in which a spacer is installed, charging of the spacer is prevented, and preventing mechanical damage to the lower layer wiring or the like as caused by the atmospheric pressure that is applied to the spacer (a function in which the spacer is electrically connected to the second electrode) must be added. Nevertheless, screen printing presents difficulties in regard to producing complex structures used to yield image-separating characteristics for separating the upper electrodes in a self-aligning manner.

Furthermore, it is also conceivable that thick-film wiring formed by subjecting Ag or the like to screen printing or the like might be laminated on top of the thin-film wiring or the like formed by vacuum film formation or another method in order to lower the wiring resistance of the second electrodes. However, in the case of screen-printed wiring using a paste of Ag, Au, or the like, the binder is baked away when the paste is sintered. In this case, since a high-temperature heat treatment is performed in a state in which oxygen from the atmosphere or the like is present, the surface of the thin film is oxidized, and the following problem arises: namely, the contact resistance between the thin film and the thick-film wiring increases, and it becomes substantially impossible to lower the wiring resistance of the second electrodes.

Furthermore, a construction in which aluminum (Al) or an aluminum alloy (Al alloy) material having a high oxidation resistance is used as a low-resistance material, and in which the upper and lower electrodes are formed from chromium (Cr), a chromium alloy (Cr alloy) or the like having a high oxidation resistance and a nobler standard electrode potential than Al, is disclosed in Japanese Laid-Open Patent Application No. 2006-107741. In Japanese Laid-Open Patent Application No. 2006-107741, the Cr, Cr alloy, or the like is selectively etched with respect to the Al or Al alloy. Furthermore, an electrode of the lower-layer Cr, Cr alloy, or the like is disposed on one end part, and on the other end part, the electrode of the lower-layer Cr, Cr alloy or the like forms an undercut with respect to the Al or Al alloy electrode. Furthermore, a manufacturing method is disclosed in which the metal material of the Cr, Cr alloy, or the like which has a nobler electrode potential than the Al or Al alloy having a base electrode potential is selected, and the undercut is formed by wet etching. The film of the upper-layer Cr, Cr alloy, or the like is thus made thicker than the film of the lower layer, and the amount of exposure of the Al or Al alloy which is not covered by the upper-layer Cr, Cr alloy, or the like is limited. The local battery action between the Al or Al alloy and Cr, Cr alloy, or the like is accordingly controlled, thus ensuring an appropriate amount of undercut.

In this construction, since deformation of the undercut portion is controlled, the self-aligning separation characteristics of the upper electrodes of the electron source pixels can be improved. Furthermore, even if the image display device passes through a high-temperature heat treatment in an oxygen-containing atmosphere in a sealing process or the like, the pixel separation characteristics do not deteriorate, and low-resistance second electrodes can be manufactured. As a result, the following special feature is obtained: namely, an image of uniform brightness can be obtained in the display region.

However, even in the construction of Japanese Laid-Open Patent Application No. 2006-107741, which has such special features, respectively different working processes must be performed simultaneously on the second electrode lower-layer Cr, as in the undercut working of one side wall for element separation, and the taper working for contact elsewhere. Thus, a drop in workability is unavoidable. Furthermore, if the taper working of the upper electrodes is insufficient, there is a risk that upper electrode disconnection may occur. Furthermore, the occurrence of such disconnections results in poor feeding to the electron sources. Moreover, because of the effects of the heat treatment during panel sealing and the like, there is a risk that the lower-layer Cr of the second electrodes will be oxidized and that fluctuations in electrical continuity or poor electrical continuity will occur. A solution to such problems has been desired.

Furthermore, along with the abovementioned drop in resistance, an increase in the thickness of the wiring cannot be avoided if a laminated wiring structure is used; this presents a risk that there will be an effect on the maintenance of a vacuum in the sealed areas.

The invention described in Japanese Laid-Open Patent Application No. 2006-66199 relates to maintaining the vacuum in the abovementioned sealed areas; in order to control a decrease in the degree of vacuum due to foaming caused by the reaction between the insulating film disposed between the first electrodes and second electrodes and the adhesive agent in the sealed areas, a construction is used in which no insulating films are caused to be present in the sealed areas.

In the invention of this Japanese Laid-Open Patent Application No. 2006-66199, no reaction occurs between an insulating film and an adhesive agent in the sealed areas; therefore, a vacuum can be reliably maintained and an image display device with a long useful life can be obtained.

On the other hand, in order to remove the insulating film from the sealed areas as in the invention of Japanese Laid-Open Patent Application No. 2006-66199, it is necessary to remove the outside parts of the insulating film from the sealed areas prior to the formation of the lead terminals of the second electrodes.

However, the insulating film doubles as a protective film for other electrodes formed in advance, the abovementioned removal complicates the after-processes, and leads to a drop in the working efficiency.

It is an object of the present invention to solve the abovementioned problems, and to provide an image display device with a long useful life and superior display characteristics, which prevents deterioration of the degree of vacuum. And it is an object of the present invention to improve the reliability of electrical feeding and continuity. And it is an object of the present invention to shorten the manufacturing process.

In order to achieve the abovementioned object, the image display device of the present invention is an image display device comprising a back-surface substrate having a plurality of first electrodes which extend in one direction and which are installed side by side in another direction perpendicular to this one direction, an insulating film formed so as to cover these first electrodes, a plurality of second electrodes which extend in the other direction on the insulating film and which are installed side by side in the one direction so as to cross the first electrodes, and an electron source which is provided in the vicinity of the intersecting parts of the first electrodes and second electrodes, and which are connected with the second electrodes; a front-surface substrate having a fluorescent layer provided in correspondence with the electron source, and further having an anode used for the application of an acceleration voltage so that electrons emitted from the electron source are directed toward the fluorescent layer; a frame disposed between the front-surface substrate and the back-surface substrate so that the two substrates are maintained at a fixed spacing; and a sealing member for sealing the frame and the two substrates in an airtight manner in a sealed area; wherein the second electrodes cover the insulating film disposed beneath these second electrodes in at least the sealed area, and place the sealing members and the insulating film in a non-contact state.

According to another aspect of the present invention, the film width of the second electrodes in the direction perpendicular to the direction in which the second electrodes extend in the sealed area is in the following relationship with the film width of the insulating film in the same direction: insulating film width <second electrode film width.

According to another aspect of the present invention, at least the sealed-area parts of the second electrodes have a laminated film construction including a lower-layer film and an upper-layer film covering this lower-layer film, and the second electrodes are formed by the insulating film disposed beneath the lower-layer film being covered by the upper-layer film together with the lower-layer film in the sealed areas.

In this aspect, the second electrodes may have a two-layer film structure in which the lower-layer film in the second electrodes is constructed from an aluminum film, and the upper-layer film is constructed from an aluminum alloy primarily composed of aluminum.

Alternatively, the second electrodes may have a four-layer film structure in which the lower-layer film is formed with a three-layer film structure in which aluminum alloy films primarily composed of aluminum are disposed with the aluminum film sandwiched in between, and the upper-layer film is formed as the aluminum alloy film.

According to this aspect, furthermore, the thickness of the lower-layer film in the second electrodes may be greater than the thickness of the upper-layer film.

According to this aspect, furthermore, the film width of the insulating film in the direction perpendicular to the direction of extension of the sealed area may be in the following relationship with the film width of the other upper-layer film and the lower-layer film in the same direction: lower-layer film width <insulating film width <upper-layer film width.

The method for manufacturing an image display device of the present invention is a method for manufacturing an image display device comprising a back-surface substrate having a plurality of first electrodes which extend in one direction and which are installed side by side in another direction perpendicular to this one direction, an insulating film formed so as to cover these first electrodes, a plurality of second electrodes which extend in the other direction on the insulating film and which are installed side by side in the one direction so as to cross the first electrodes, and an electron source which is provided in the vicinity of the intersecting parts of the first electrodes and second electrodes, and which are connected with the second electrodes; a front-surface substrate which has a fluorescent layer provided in correspondence with the electron source, and further having an anode used for the application of an acceleration voltage so that the electrons emitted from the electron source are directed toward the fluorescent layer; a frame disposed between the front-surface substrate and the back-surface substrate so that the two substrates are maintained at a fixed spacing; and a sealing member for sealing the frame and the two substrates in an airtight manner in a sealed area, the method comprising the steps of: forming first electrodes which are in the form of stripes and which have a tunnel insulating layer and a field insulating film on the surface of the back-surface substrate; covering the surface of the substrate that includes the first electrodes by using the insulating film; forming a stripe-form lower-layer film which constitutes a portion of the second electrodes and which is substantially perpendicular to the first electrodes on the insulating film using a first metal thin film; forming a through-hole that reaches the field insulating film in a portion between the tunnel insulating layer of the insulating film and the lower-layer film; removing the remaining part except for an area surrounded by the sealed area of the insulating films and an area beneath the lower-layer film of the exposed terminal part of the second electrodes; covering a surface that includes the lower-layer film, an opening, and the like by using a second metal thin film; working the second metal thin film to form an upper-layer film that continuously covers a side wall from an upper surface of the lower-layer film; removing a portion of the insulating films beneath one of the side walls of the lower-layer films to form an undercut part beneath one of the side wall of the lower-layer films; removing the insulating film laminated on the tunnel insulating layer of the first electrodes to expose the tunnel insulating layer; forming an upper electrode film across the top of the second electrode from above the tunnel insulating layer; and cutting the upper electrode film in the undercut part to perform element separation from the adjacent second electrode and forming an upper electrode on the second electrodes continuously from above the tunnel insulating layer.

According to another aspect of the present invention, the first metal is aluminum, and the second metal is an aluminum alloy primarily composed of aluminum.

By using a construction in which the insulating film is covered and hidden by the second electrodes, it is possible to prevent contact between the insulating film and the sealing member, to prevent a deterioration in vacuum caused by foaming, to ensure the reliability of electron radiation characteristics, and to achieve a long useful life. Furthermore, in cases where the second electrodes are formed with a laminated construction of a lower-layer film and upper-layer film, it is possible to reduce the resistance of the second electrodes, and to improve the reliability of electrical feeding and continuity. Furthermore, in cases where insulating films are left on the undersides of the second electrodes in the sealed areas, it is possible to utilize these insulating films as protective films for other electrodes in subsequent processes, and a drop in the working efficiency can be prevented.

### BRIEF DESCRIPTION OF THE DRAWINGS

FIG. 1A is a schematic plan view illustrating the construction of an embodiment of the image display device of the present invention;

FIG. 1B is a schematic side view illustrating the construction of an embodiment of the image display device of the present invention;

FIG. 2 is a schematic sectional view along line A-A in FIG. 1B;

FIG. 3 is a schematic sectional view of the portion running along line B-B in FIG. 2 and the portion of the front-surface substrate corresponding to this;

FIG. 4A is a schematic sectional view along line C-C in FIG. 2;

FIG. 4B is a schematic sectional view along line D-D in FIG. 2;

FIG. 5 is a schematic plan view showing an example of the insulating film pattern in FIG. 2;

FIG. 6A is a schematic plan view illustrating the manufacturing process of the image display device of the present invention;

FIG. 6B is a sectional view along line E-E in FIG. 6A;

FIG. 6C is a sectional view along line F-F in FIG. 6A;

FIG. 7A is a plan view illustrating the manufacturing process of the image display device of the present invention;

FIG. 7B is a sectional view along line E-E in FIG. 7A;

FIG. 7C is a sectional view along line F-F in FIG. 7A;

FIG. 8A is a plan view illustrating the manufacturing process of the image display device of the present invention;

FIG. 8B is a sectional view along line E-E in FIG. 8A;

FIG. 8C is a sectional view along line F-F in FIG. 8A;

FIG. 9A is a plan view illustrating the manufacturing process of the image display device of the present invention;

FIG. 9B is a sectional view along line E-E in FIG. 9A;

FIG. 9C is a sectional view along line F-F in FIG. 9A;

FIG. 10A is a plan view illustrating the manufacturing process of the image display device of the present invention;

FIG. 10B is a sectional view along line E-E in FIG. 10A;

FIG. 10C is a sectional view along line F-F in FIG. 10A;

FIG. 11A is a plan view illustrating the manufacturing process of the image display device of the present invention;

FIG. 11B is a sectional view along line E-E in FIG. 11A;

FIG. 11C is a sectional view along line F-F in FIG. 11A;

FIG. 12A is a plan view illustrating the manufacturing process of the image display device of the present invention;

FIG. 12B is a sectional view along line E-E in FIG. 12A;

FIG. 12C is a sectional view along line F-F in FIG. 12A;

FIG. 13A is a plan view illustrating the manufacturing process of the image display device of the present invention;

FIG. 13B is a sectional view along line E-E in FIG. 13A;

FIG. 13C is a sectional view along line F-F in FIG. 13A;

FIG. 14A is a plan view illustrating the manufacturing process of the image display device of the present invention;

FIG. 14B is a sectional view along line E-E in FIG. 14A;

FIG. 14C is a sectional view along line F-F in FIG. 14A;

FIG. 15A is a plan view illustrating the manufacturing process of the image display device of the present invention;

FIG. 15B is a sectional view along line E-E in FIG. 15A;

FIG. 15C is a sectional view along line F-F in FIG. 15A;

FIG. 16A is a plan view illustrating the manufacturing process of the image display device of the present invention;

FIG. 16B is a sectional view along line E-E in FIG. 16A;

FIG. 16C is a sectional view along line F-F in FIG. 16A;

FIG. 17A is a plan view illustrating the manufacturing process of the image display device of the present invention;

FIG. 17B is a sectional view along line E-E in FIG. 17A; and

FIG. 17C is a sectional view along line F-F in FIG. 17A.

### DETAILED DESCRIPTION OF THE INVENTION

An embodiment of the present invention will be described in detail hereinbelow with reference to the drawings.

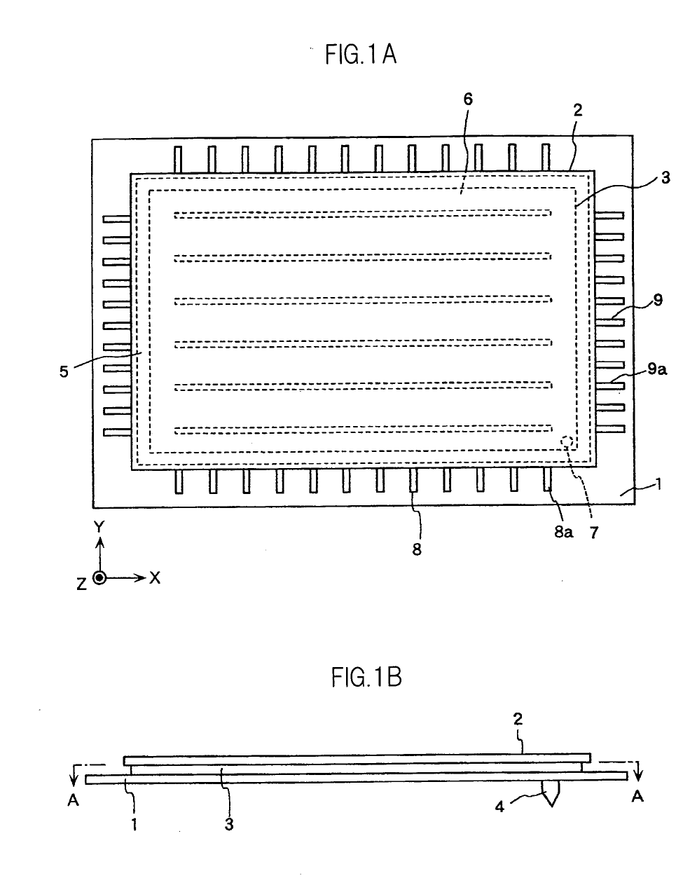

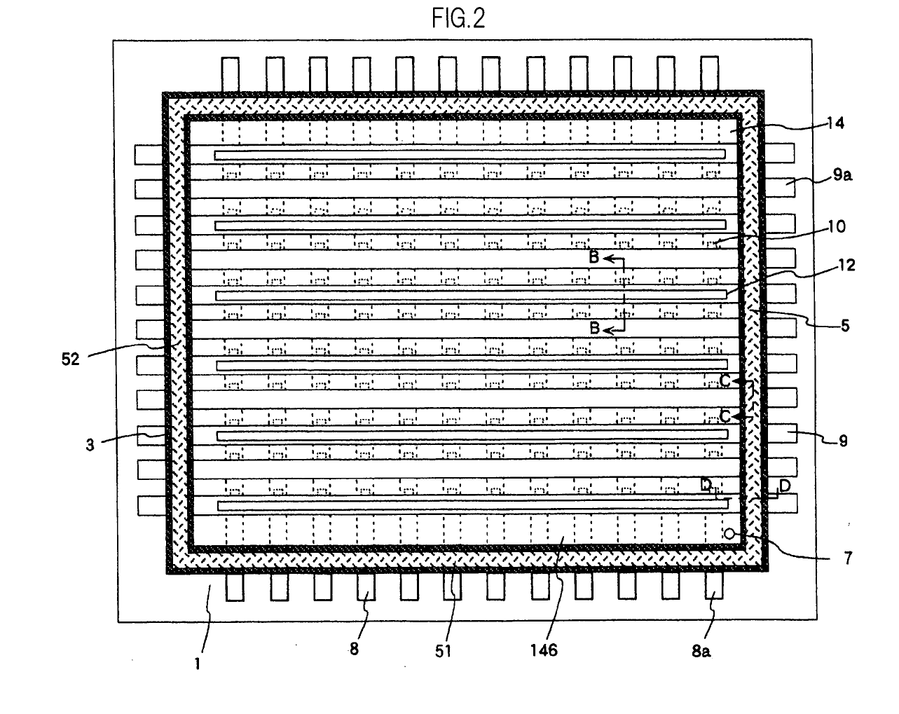

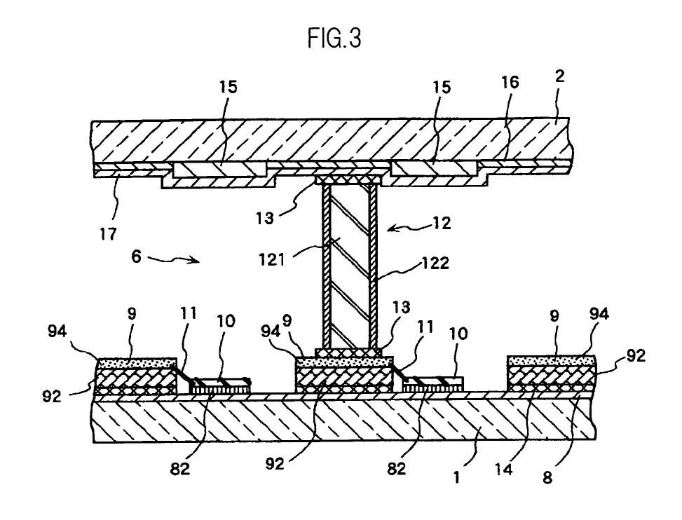

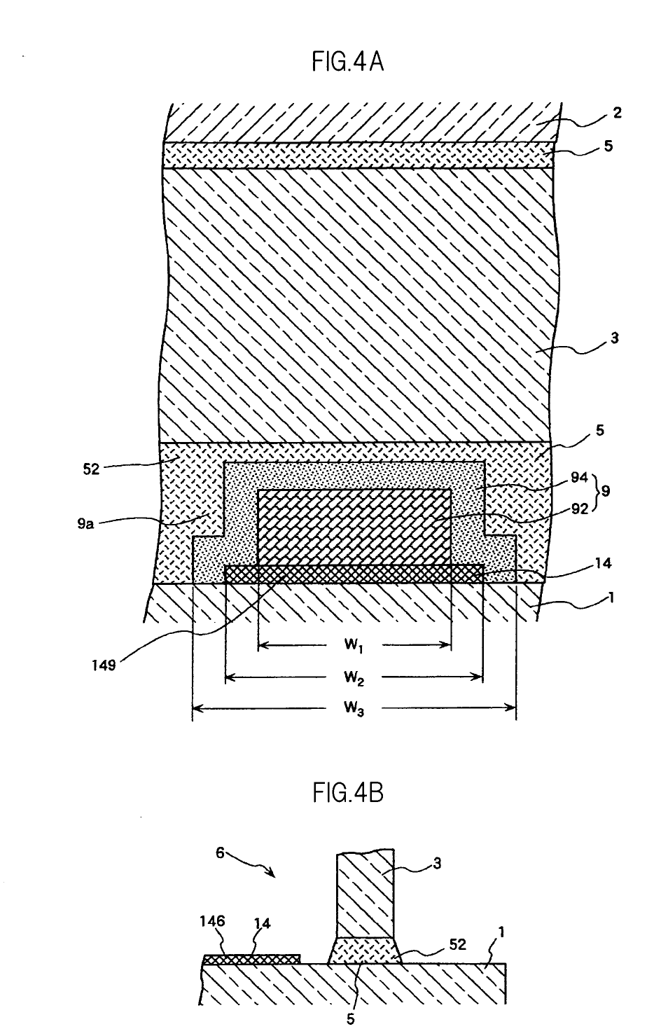

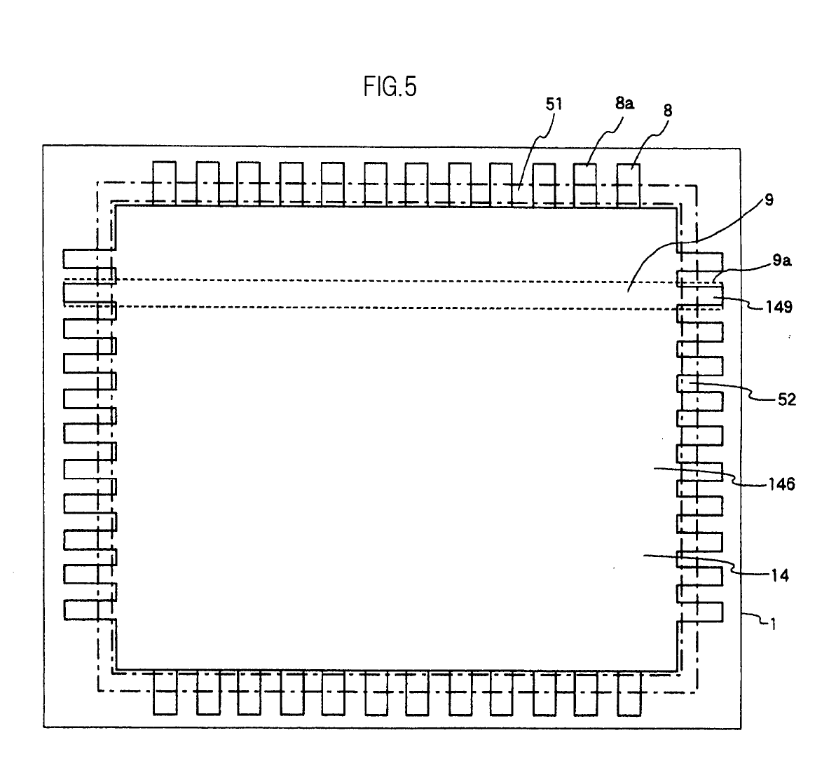

FIGS. 1A through 5 are schematic views for describing the configuration of an image display device according to an embodiment of the present invention, wherein FIG. 1A is a plan view, FIG. 1B is a side view of FIG. 1A, FIG. 2 is a cross-sectional view along the line A-A in FIG. 1B, FIG. 3 is a cross-sectional view of a front-surface substrate of the portion along the line B-B in FIG. 2 and of the portion corresponding to the back-surface substrate thereof, FIG. 4A is a cross-sectional view along the line C-C in FIG. 2, FIG. 4B is a cross-sectional view along the line D-D in FIG. 2, and FIG. 5 is a plan view showing an example of the insulating film pattern in FIG. 2.

As shown in FIGS. 1A through 5, the image display device according to the present embodiment includes a back-surface substrate 1, a front-surface substrate 2, a frame 3, a ventilation pipe 4, a sealing member 5, a vacuum area 6 including a display area, a through hole 7, a first electrode 8, a first electrode lead-out terminal 8a, a second electrode 9, a second electrode lead-out terminal 9a, an electron source 10, a connecting line 11, a spacer 12, a bonding member 13, an insulating film 14, fluorescent layers 15, a light-blocking BM (black matrix) film 16, a metal back (anodic electrode) 17 composed of a metal thin film, sealed areas 51, 52, a lower-layer film 92, and an upper-layer film 94.

The back-surface substrate 1 and the front-surface substrate 2 have a substantially rectangular shape, and are both configured from glass plates having a thickness of several millimeters, e.g., about 1 to 10 mm. The frame 3 has a frame shape. The frame 3 is configured from, e.g., sintered fritted glass, a glass plate, or the like, having a substantially rectangular shape as a single unit or as a plurality of members; and the frame is placed between the aforementioned substrates (the back-surface substrate 1 and the front-surface substrate 2). The frame 3 is placed at the peripheral edges between the substrates (between the back-surface substrate 1 and the front-surface substrate 2) and the end surfaces of the frame are hermetically bonded to the two substrates (the back-surface substrate 1 and the front-surface substrate 2). The thickness of the frame 3 is set between several millimeters and several tens of millimeters, and the height is set to a dimension substantially equal to the gap between the substrates (between the back-surface substrate 1 and the front-surface substrate 2). The ventilation pipe 4 is fixed to the back-surface substrate 1. The sealing member 5 is composed of, e.g., fritted glass having a low melting point, such as a composition containing 75 to 80 wt % of PbO, approximately 10 wt % of B₂O₃, and 10 to 15 wt % of other compounds. Other possible examples for the sealing member 5 include glass materials containing an amorphous type of fritted glass. The sealing member 5 is bonded and hermetically sealed between the frame 3 and the substrates (the back-surface substrate 1 and the front-surface substrate 2).

The vacuum area 6, which contains the frame 3 and the display area enclosed by the substrates (the back-surface substrate 1 and front-surface substrate 2) and the sealing member 5, is ventilated via the ventilation pipe 4, maintaining a degree of vacuum of, e.g., 10⁻⁵ to 10⁻⁷ Torr. The ventilation pipe 4 is attached to the external surface of the back-surface substrate 1 as previously described, and communicates with the through hole 7 formed through the back-surface substrate 1. The ventilation pipe 4 is sealed after ventilation is complete.

The first electrode 8 has a striped formation. The first electrode 8 is composed of, e.g., an aluminum (Al) film, an aluminum-neodymium (Al—Nd) film, or the like, and extends in one direction (Y direction) on the inside surface of the back-surface substrate 1 while being aligned in the other direction (X direction). The first electrode 8 comprises a tunnel insulating film and a field insulating film on the top surface, as will be described later. The first electrode 8 runs from the vacuum area 6 hermetically through the sealed area 51 in the hermetically sealed part on the lengthwise side of the frame 3 and back-surface substrate 1, and extends up to the end of the lengthwise side of the back-surface substrate 1. This distal end constitutes the first electrode lead-out terminal 8a.

The second electrode 9 has a striped formation, and the second electrode 9 is disposed on the first electrode 8 via the insulating film 14. The second electrode 9 extends in the other direction (X direction) intersecting with the first electrode 8 while being aligned in the one direction (Y direction). The second electrode 9 has a laminated film structure containing a lower-layer film 92 composed of an aluminum film and an upper-layer film 94 composed of an aluminum alloy film primarily composed of aluminum. The second electrode 9 runs from the vacuum area 6 containing the display area hermetically through the sealed area 52 in the hermetically sealed part on the widthwise side of the frame 3 and back-surface substrate 1, and extends up to the end of the widthwise side of the back-surface substrate 1. The second electrode lead-out terminal 9a is the distal end of the second electrode 9.

The insulating film 14 placed between the second electrode 9 and the first electrode 8 is formed into the pattern shown in FIG. 5. Specifically, the insulating film 14 has a configuration comprising a matrix 146, which is enclosed by the sealed area 51 and the sealed area 52 of the frame 3 and which is disposed over substantially the entire surface in the vacuum area 6 containing the display area; and a leg part 149 which is disposed to protrude continuously from the matrix 146 in accordance with the portions of the second electrode lead-out terminal 9a of the second electrode 9 that protrude farther outward than the sealed area 52. The details of the configurations of the insulating film 14, the second electrode 9, the sealed area 51, the sealed area 52, and other components will be described further below. Possible examples of materials that can be used for the insulating film 14 include a silicon oxide or silicon nitride film, silicon, or other such materials, but a silicon nitride film is used in this case. In cases in which the field insulating film has pinholes, the insulating film 14 fulfills the role of obscuring these defects and preserving insulation between the first electrode 8 and the second electrode 9.

In the insulating film 14, the matrix 146 comprises an undercut below the side wall of a scanning signal line 9, thereby constituting an element-separating structure.

The element separation in the present embodiment is achieved with a configuration in which the second electrode 9 is conductive with part of the electron source 10 disposed on the sides of the second electrode 9, and is not conductive with the other part due to being divided by the undercut.

The undercut is configured by etching a concavity into the insulating film 14 in the bottom of the side wall of the second electrode 9 at the side where the second electrode 9 is not conductive with the electron source 10, and forming eaves in the second electrode 9 at this portion.

The undercut separates elements by dividing the upper electrode that links the second electrode 9 with a tunnel insulating film 82 constituting the electron source 10, and establishing nonconduction with the rest of the electron source. On the conductive side, the insulating film 14 is embedded beneath the second electrode 9.

Next, the electron source 10 is an MIM electron source, which is a type of electron source disclosed in, e.g., Japanese Laid-open Patent Application No. 2004-363075 and Japanese Laid-open Patent Application No. 2006-107741. This electron source 10 is provided to the tunnel insulating film on the first electrode 8 in the vicinity of the intersections between the second electrode 9 and the first electrode 8. This electron source 10 is connected with the second electrode 9 by the connecting line 11.

The spacer 12 is composed of a ceramic or another such insulating material, and is configured from an insulating base 121 that has a small distribution of resistance values and that is shaped into a rectangular thin plate, and a film-covered layer 122 that covers the surface of the insulating base 121 and that has a small distribution of resistance values. The spacer 12 has resistance values of about 10⁸ to 10⁹ Ωcm, and has an overall configuration with a small distribution of resistance values. A spacer 12 is erected substantially parallel to the frame 3 on every other strip of the second electrode 9, and is fixed to both substrates (the back-surface substrate 1 and the front-surface substrate 2) by the bonding member 13. The spacer 12 need only be bonded and fixed to the substrate at one end, and furthermore, the spacer 12 is ordinarily disposed for a plurality of pixels at a time in positions that do not interfere with the operation of the pixels.

The dimensions of the spacer 12 are set according to the substrate dimensions, the height of the frame 3, the substrate material, the gaps between spacer placements, the spacer material, and other factors. Commonly, the height is substantially the same dimension as the previously described frame 3, the thickness is several tens of μm to several mm or less, and the length is about 20 mm to 1000 mm. A greater length than this is also possible, but the length is preferably about 80 mm to 300 mm, which are practical values.

On the inside surface of the front-surface substrate 2 where one end side of the spacer 12 is fixed, fluorescent layers 15 for the colors red, green, and blue are placed in windows partitioned by the light-blocking BM (black matrix) film 16. A metal back (anodic electrode) 17 composed of a metal thin film is provided by, e.g., vapor deposition so as to cover these fluorescent layers 15, forming a fluorescent surface. The metal back 17 is a photoreflective film for reflecting light emitted towards the opposite side of the front-surface substrate 2, i.e., towards the back-surface substrate 1, back to the front-surface substrate 2, and increasing the efficiency of extracting the emitted light. Furthermore, the metal back 17 also has the function of preventing the surfaces of the fluorescent particles from being electrically charged. The metal back 17 is depicted as a surface electrode, but the metal back can also be a striped electrode that intersects with the second electrode 9 and that is divided at each pixel row.

For the fluorescent elements, e.g.; Y₂O₃:Eu and Y₂O₂S:Eu can be used for the color red; ZnS:Cu, Al, and Y₂SiO₅:Tb can be used for the color green; and ZnS:Ag, Cl, ZnS:Ag, and Al can be used for the color blue. In these fluorescent layers 15, the mean particle size of the fluorescent particles is, e.g., 4 μm to 9 μm, and the film thickness is, e.g., about 10 μm to 20 μm.

The following is a detailed description of the relationship between the previously described second electrode 9, the insulating film 14, the sealing member 5, and other components. First, in the sealed area 52, the leg part 149 of the insulating film 14 is covered by the second electrode lead-out terminal 9a, and is disposed in a state of non-contact with the sealing member 5, as shown in FIG. 4A. This sealed area 52 comprises the leg part 149 having a width W2 constituting part of the insulating film 14 on the back-surface substrate 1, on top of which is placed the lower-layer film 92 which has a width W1 smaller than the leg part 149 and which constitutes part of the second electrode lead-out terminal 9a. The distal end of the leg part 149 extends up to substantially the same position as the second electrode lead-out terminal 9a.

If the film width W2 of the leg part 149 is less than the film width W1 of the lower-layer film 92, there is a risk that the difference in film widths will result in a vacuum leak path. Therefore, it is preferable that the film widths of the lower-layer film 92 and leg part 149 have the previously described relationship of W1<W2. Furthermore, disposed on the top surface thereof is the upper-layer film 94, which covers both the lower-layer film 92 and the leg part 149, which has a film width W3, and which constitutes the rest of the second electrode lead-out terminal 9a; and this upper-layer film 94 is configured to prevent contact between the insulating film 14 and the sealing member 5. The film widths referred to herein refer to a dimension in a direction perpendicular to the direction in which the second electrode 9 extends.

There is no insulating film 14 between second electrode lead-out terminals 9a of the sealed area 52 as shown in FIGS. 4B and 5, where only the sealing member 5 is present.

In the embodiment described above, the leg part 149 of the insulating film 14 is located in the sealed area 52 through which the second electrode lead-out terminal 9a passes hermetically, and the film width W2 of the leg part 149 is set to be more than the film width W1 of the lower-layer film 92 superposed thereon. Therefore, the insulating film 14 can be used as a protective film in later steps, and reductions in operating efficiency can be prevented. The size relationship between the film widths of the leg part 149 and the lower-layer film 92 can also prevent occurrences of vacuum leak paths as well as preventing deterioration of the vacuum.

Furthermore, the leg-part 149 of the insulating film 14 and the lower-layer film 92 are covered by the upper-layer film 94, which has a greater film width W3 than either of the two, thereby eliminating foaming that results from the reaction between the insulating film 14 and the sealing member 5, and preventing a decrease in the vacuum that accompanies foaming. Additionally, the absence of the insulating film 14 between the second electrode lead-out terminals 9a eliminates foaming in these portions, and makes it possible to prevent a decrease in the vacuum that accompanies foaming throughout the entire image display device. Furthermore, the resistance of the second electrode 9 is reduced.

In the present embodiment, the second electrode 9 is made of an aluminum film or an aluminum alloy film primarily composed of aluminum, but other metal materials can also of course be used.

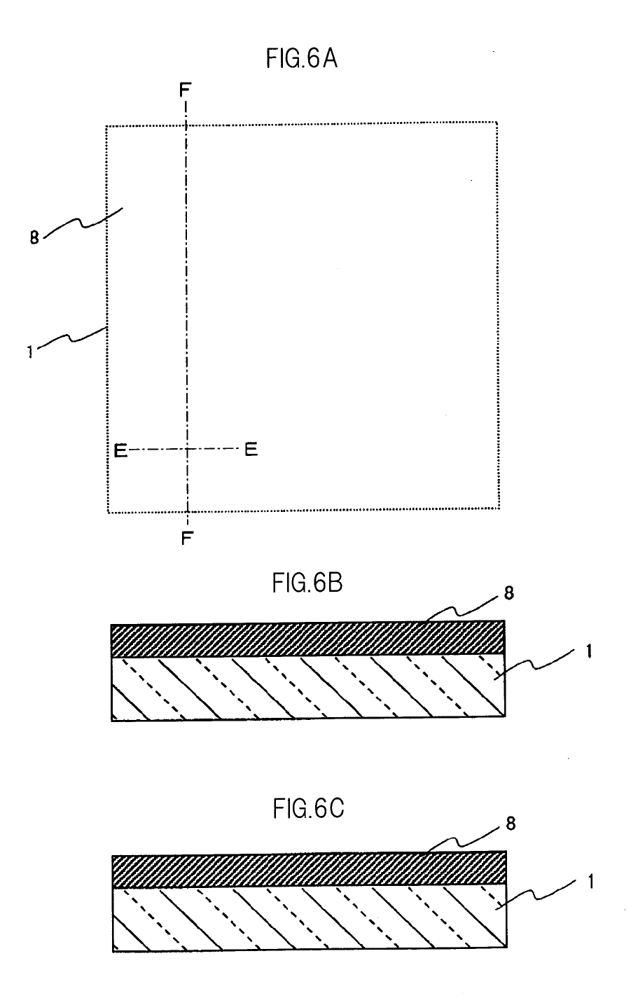

The following is a description, made with reference to FIGS. 6A through 17C, of the steps for manufacturing the signal lines, electrode source, and other components of the embodiment described above, in an embodiment of the method for manufacturing the image display device of the embodiment described above. In FIGS. 6A through 17C, FIGS. 6A, 7A, 8A, 9A, 10A, 11A, 12A, 13A, 14A, 15A, 16A, and 17A are schematic plan views; FIGS. 6B, 7B, 8B, 9B, 10B, 11B, 12B, 13B, 14B, 15B, 16B, and 17B are schematic cross-sectional views along the lines E-E in FIGS. 6A, 7A, 8A, 9A, 10A, 11A, 12A, 13A, 14A, 15A, 16A, and 17A; and FIGS. 6C, 7C, 8C, 9C, 10C, 11C, 12C, 13C, 14C, 15C, 16C, and 17C are schematic cross-sectional views along the lines F-F in FIGS. 6A, 7A, 8A, 9A, 10A, 11A, 12A, 13A, 14A, 15A, 16A, and 17A. The electron source is an MIM electron source.

First, a metal film for the first electrode 8 is formed over substantially the entire surface of an insulating substrate made of glass or the like, which constitutes the back-surface substrate 1, as shown in FIGS. 6A through 6C.

Either aluminum (Al) or an aluminum alloy primarily composed of aluminum is used as the material for the first electrode 8. One reason for using Al is to utilize its ability to form a high quality insulating film through anodic oxidation. An Al—Nd alloy doped with 2 atomic weight % of neodymium is used in this case. Sputtering is used to form the film, and the film thickness is 600 nm.

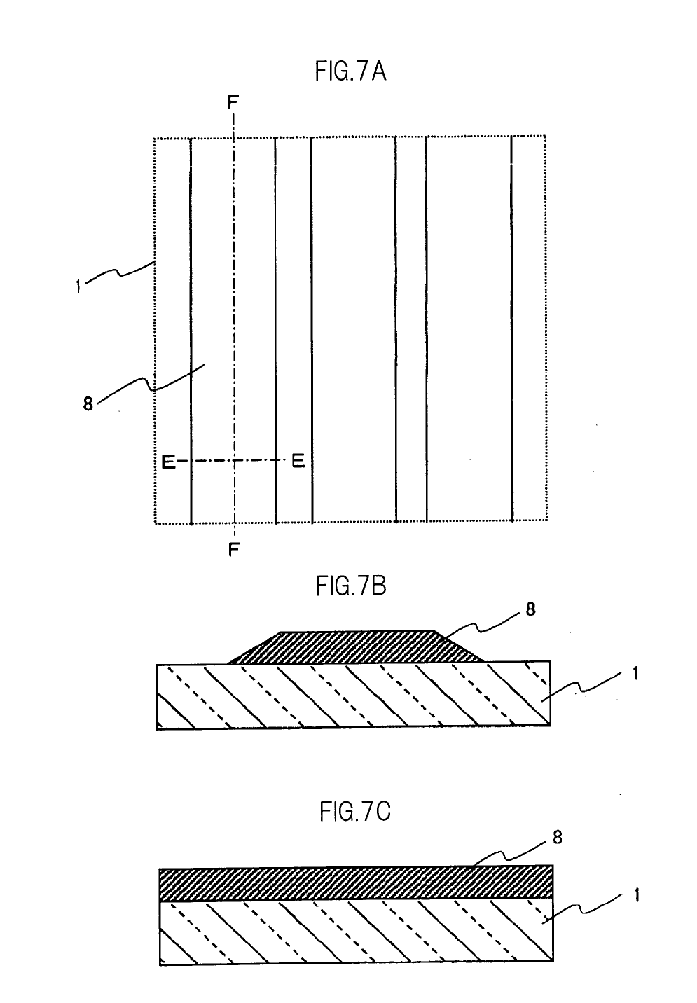

After the film is formed, the stripe-shaped first electrode 8 is formed by a patterning step and an etching step (FIGS. 7A through 7C). The wiring width of the first electrode 8 differs depending on the size and resolution of the image display device. In this case, the wiring width is generally about the pitch of the sub-pixels, that is generally about 100 to 200 micrometers (μm). The etching used here is, e.g., wet etching in a mixed aqueous solution of phosphoric acid, acetic acid, and nitric acid. Since the wiring has a wide and simple striped structure, the resist can be patterned by inexpensive proximity exposure, printing, or another such method.

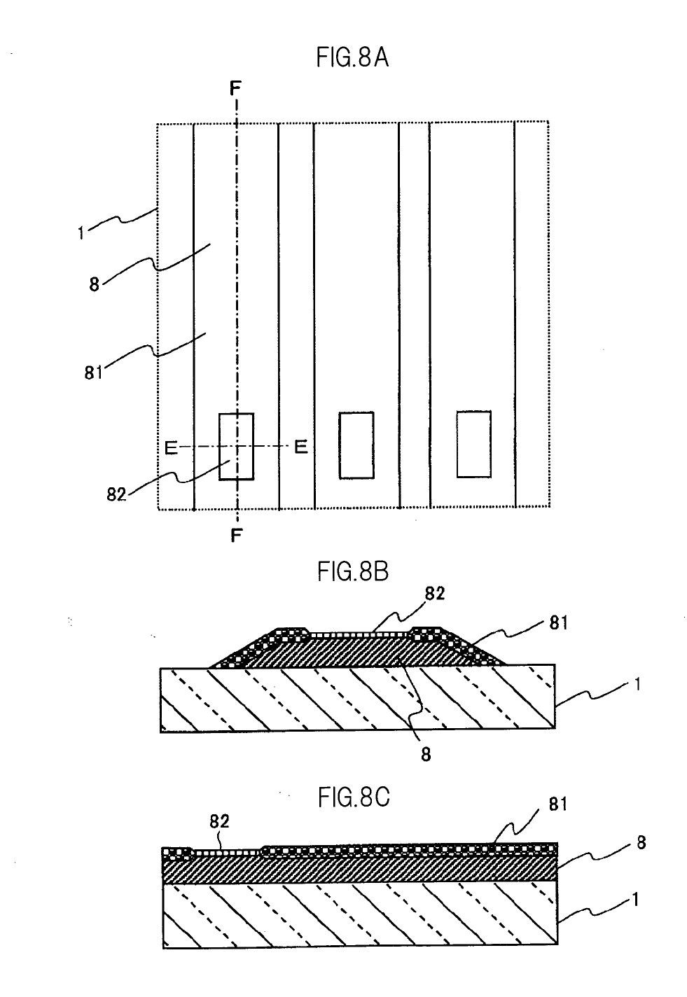

Next, the electron emission part is restricted on the surface of the first electrode 8 to form a field insulating film 81 and a tunnel insulating layer 82 for preventing static focusing on the edge of the first electrode 8 (FIGS. 8A through 8C). A resist film is used to mask the region corresponding to the portion that will become the electron emission part in the substantial center of the film width of the first electrode 8 shown in FIGS. 8A through 8C, and the rest of the portion is selectively subjected to heavy anodic oxidation to form the field insulating film 81 which will be a protective insulating film. If a chemical voltage of 200 V is used in this operation, a field insulating film 81 having a thickness of about 270 nm will be formed.

The resist film is then removed and the rest of the surface of the first electrode 8 is subjected to anodic oxidation. For example, if the chemical voltage is 6 V, a tunnel insulating layer 82 having a thickness of about 10 nm is formed on the first electrode 8 (FIGS. 8A through 8C).

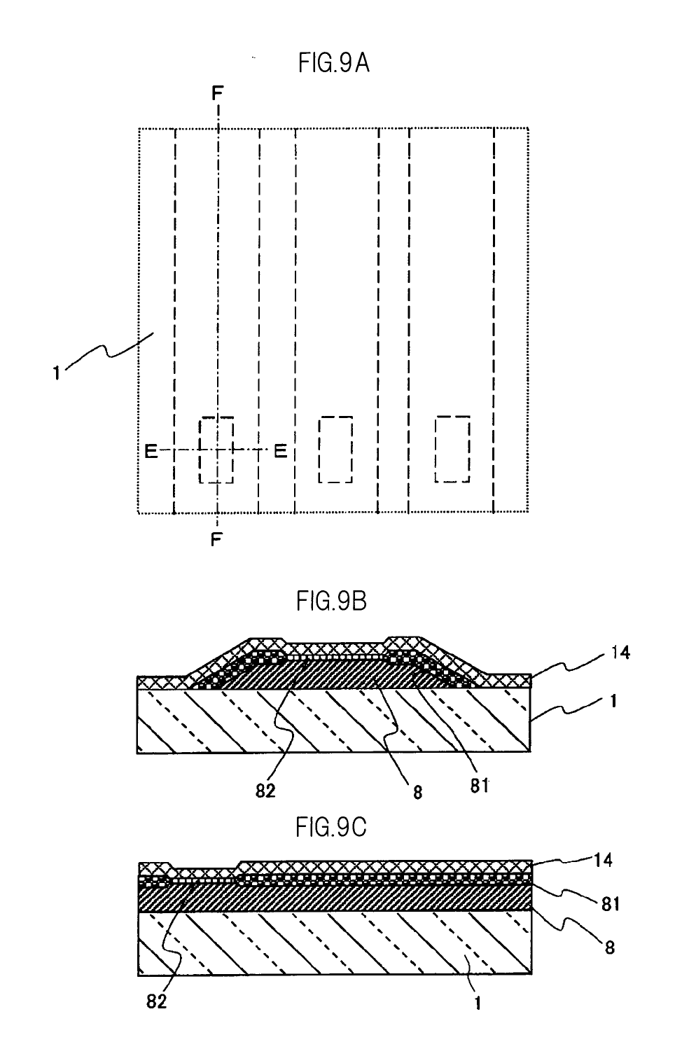

Next, the insulating film (interlayer insulating film) 14 is formed by sputtering (FIGS. 9A through 9C). CVD can be used to form the film. The material for the insulating film 14 can be, e.g., a silicon oxide or silicon nitride film, silicon, or another such material. The insulating film 14 herein is formed using a silicon nitride film SiN formed by reactive sputtering in an atmosphere of Ar and N₂, and the thickness of the insulating film 14 is 200 nm.

In cases in which the field insulating film 81 formed by anodic oxidation has pinholes, the insulating film 14 fulfills the role of obscuring these defects and preserving insulation between the first electrode 8 and the second electrode 9.

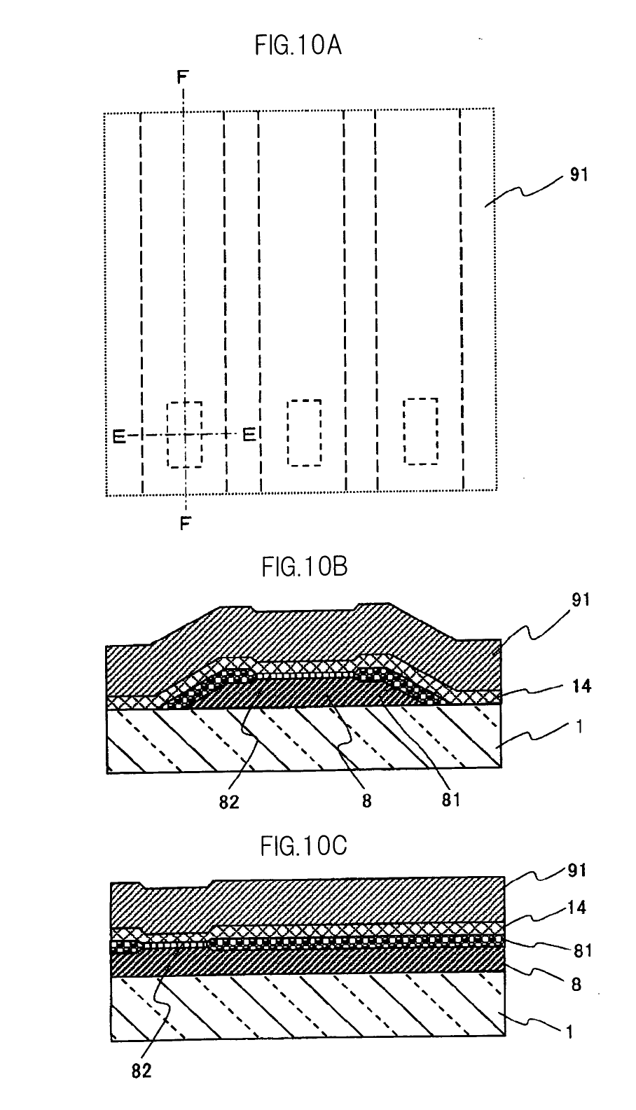

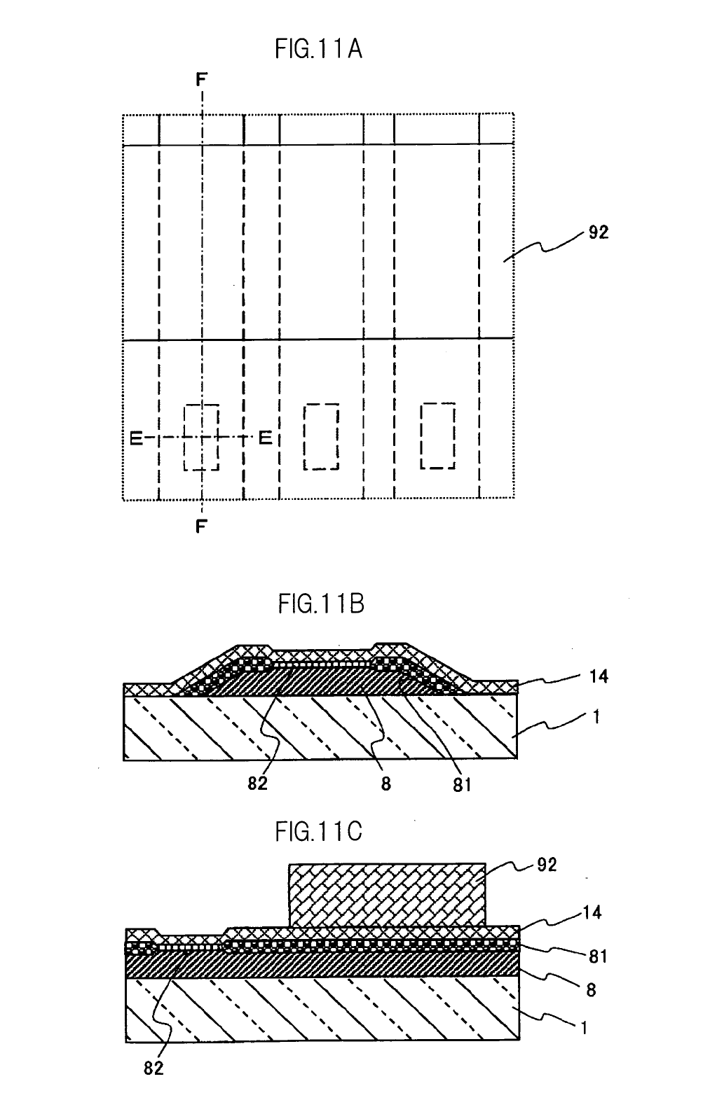

Next, an aluminum film 91 for the second electrode 9 is formed by sputtering so as to cover the entire surface of the insulating film 14. The thickness of the aluminum film 91 is 4.5 μm (FIGS. 10A through 10C). Next, the aluminum film 91 is processed by a photoetching step, and a lower-layer film 92 of the striped second electrode 9 that extends perpendicular to the first electrode 8 is formed at a position between tunnel insulating layers 82 (not shown) that are the same color and that are separated by a specific distance from the tunnel insulating layer 82 (FIGS. 11A through 11C). The cross section perpendicular to the direction in which the lower-layer film 92 extends is substantially rectangular. The etching in this process is, e.g., wet etching in a mixed aqueous solution of phosphoric acid, acetic acid, and nitric acid. Configuring the lower-layer film 92 from aluminum is preferable for the material of the second electrode in that this second electrode is low-resistance and the process is made easier by adjusting the ratio of phosphoric acid, acetic acid, and nitric acid in the etching solution, thereby specifically increasing the ratio of nitric acid, which lowers the adhesiveness of the resist end surface.

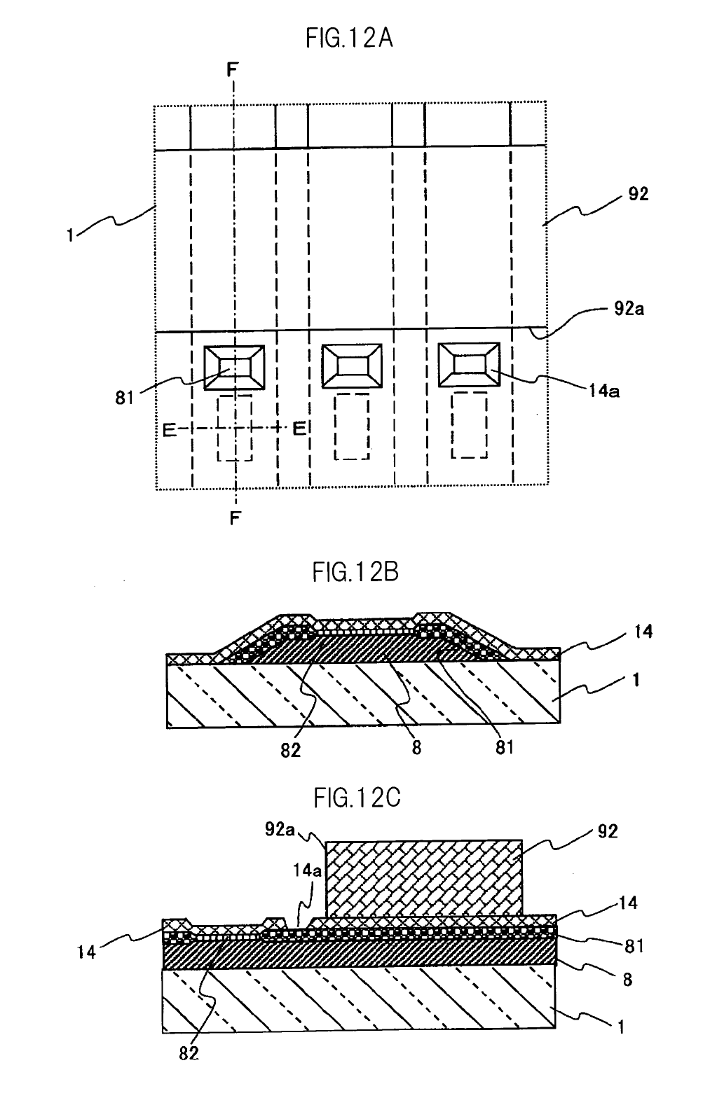

Next, an opening 14a facing the surface of the field insulating film 81 is formed between the tunnel insulating layer 82 and lower-layer film 92 of the insulating film 14 (FIGS. 12A through 12C). This opening 14a has a substantially rectangular shape in a plan view, the shape being substantially conical in the depth direction. This opening can be formed by photolithography. The opening is positioned within the line width of the first electrode 8 and between the tunnel insulating layer 82 and one side wall 92a of the lower-layer film 92, and the side walls of the opening 14a are tapered. This tapered shape makes it difficult for the metal film laid thereon to form steps in this portion.

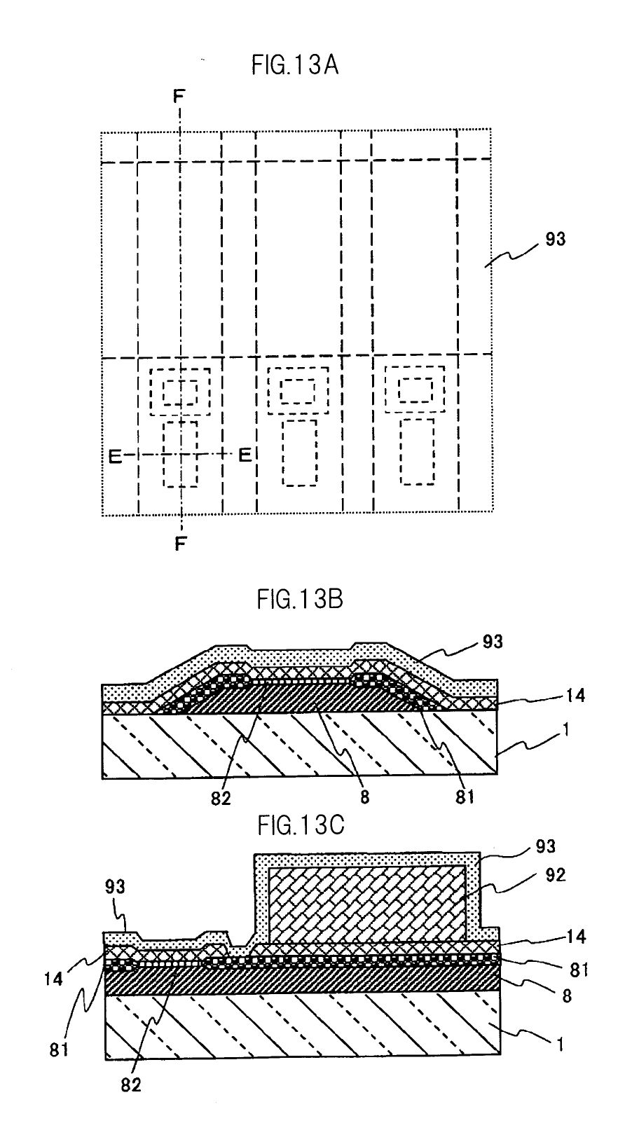

Next, an aluminum alloy film 93 primarily composed of aluminum is formed over the entire top surface of the lower-layer film 92, the opening, and the other components (FIGS. 13A through 13C). This aluminum alloy film 93 is the aforementioned aluminum-neodymium film doped with 2 atomic weight % of neodymium (Nd), and is formed by sputtering. The thickness of the aluminum alloy film 93 is 300 nm which is thinner than the lower-layer film 92 in this case.

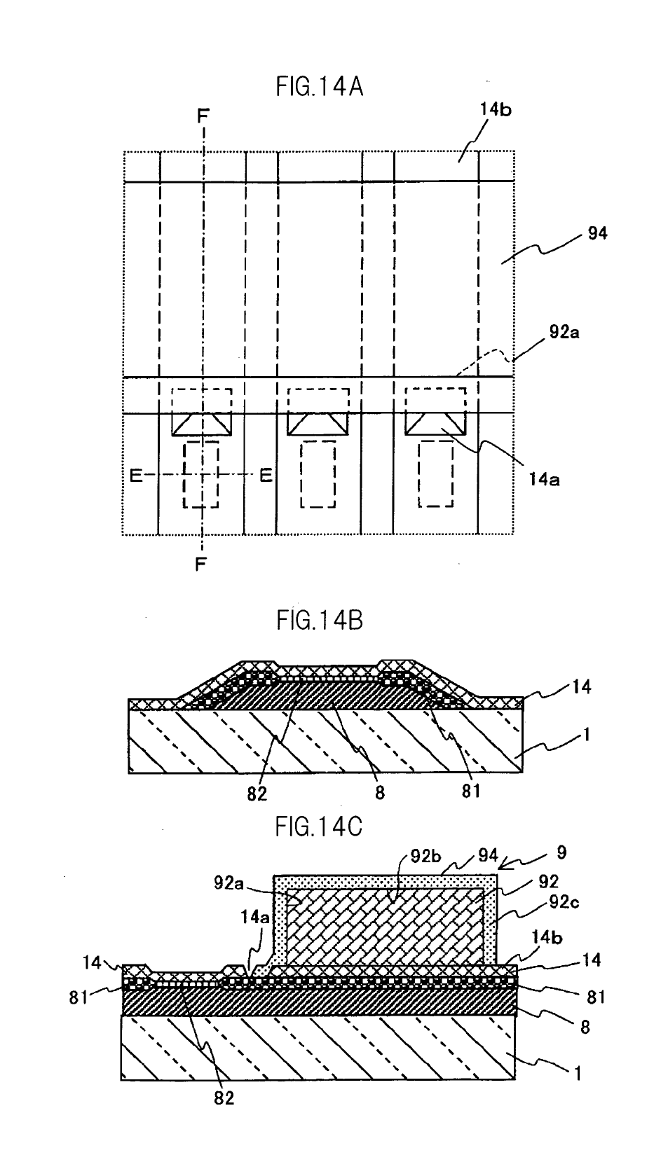

The upper-layer film 94 is processed by photoetching after the film is formed, laid over the top surface 92b and side walls 92a, 92c so as to cover the lower-layer film 92, and is further laid continuously from one side wall 92a of the lower-layer film 92 up to part of the opening 14a (FIGS. 14A through 14C).

At the other side wall 92c of the lower-layer film 92, for the sake of element separation, the upper-layer film 94 is not laid over a middle part 14b of the insulating film 14 that extends from the outer side portion of the side wall 92c towards the adjacent second electrode 9, and the middle part 14b is exposed. The second electrode 9 is configured from the laminated film containing the upper-layer film 94 composed of the aluminum alloy film 93 and the lower-layer film 92 composed of the aluminum film 91.

When formed from a laminated film structure containing the aluminum alloy film 93, the second electrode 9 is preferably formed so that the resistivity of the aluminum film 91 constituting the lower-layer film 92 is lower than the resistivity of the aluminum alloy film 93 constituting the upper-layer film 94.

Next, the middle part 14b of the insulating film 14 composed of SiN is subjected to etching. This etching is dry etching in which isotropic etching is possible. During this etching, the parts other than the middle part 14b are covered by a protective film. This dry etching of SiN is performed by a mixed gas of CF₄ and O₂, a mixed gas of SF₆ and O₂, or another such mixed gas.

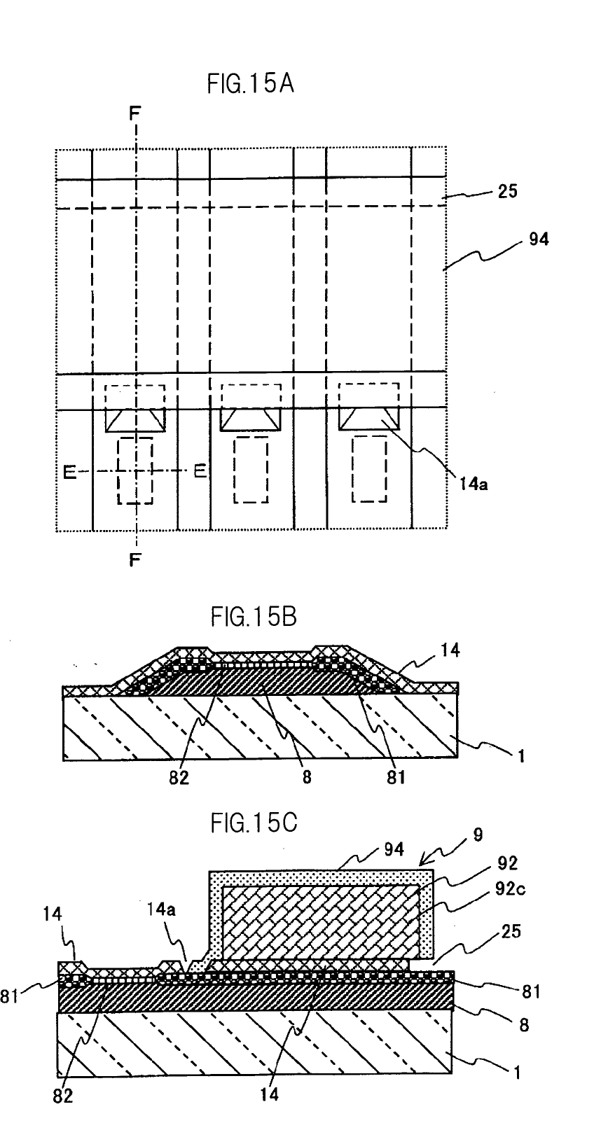

As a result of this dry etching, part of the middle part 14b of the insulating film 14 composed of SiN is selectively removed. The middle part 14b is also removed by this dry etching. Furthermore, the part of the middle part 14b that continues up to the lower side of the lower-layer film 92 is cut out by side etching, giving the lower-layer film 92 the shape of eaves, and this portion forms an undercut 25 (FIGS. 15A through 15C).

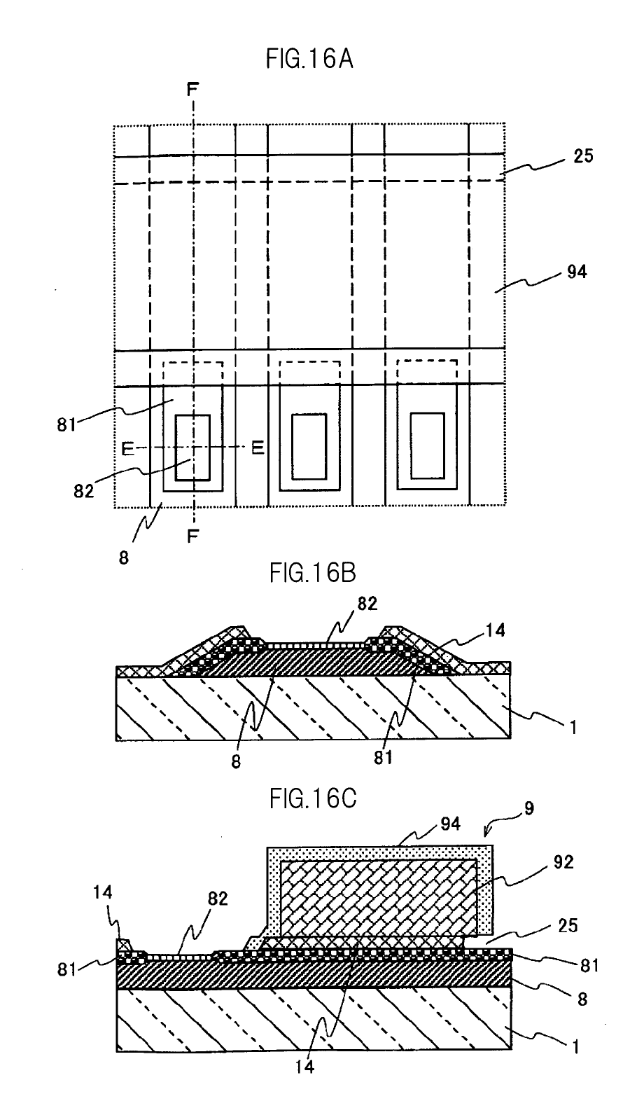

Next, the interlayer insulating film 14 on the tunnel insulating layer 82 is removed to expose the tunnel insulating layer 82. The etching can be performed by, e.g., the previously described dry etching using a mixed gas primarily composed of CF₄ or SF₆ (FIGS. 16A through 16C). This step for removing the insulating film 14 on the tunnel insulating layer 82 can be performed at the same time as the processing of the undercut 25.

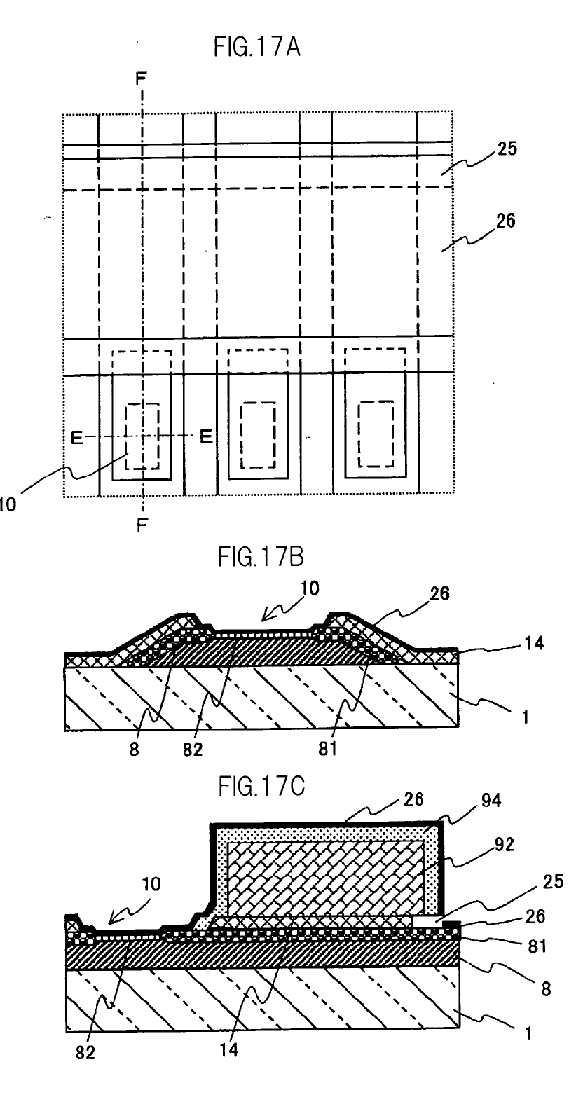

Next, an upper electrode 26 is formed. Sputtering, for example, is used to form this electrode. A laminated film containing, e.g., Ir, Pt, and Au is used as the upper electrode 26, and the thickness of the upper electrode 26 is, e.g., 3 nm. The upper electrode 26 is formed into a shape that continuously covers the area from the tunnel insulating layer 82 to the field insulating film 81 and the upper-layer film 94, and is separated from the adjacent second electrode (not shown) by the undercut 25 (FIGS. 17A through 17C).

In the steps described above, the first electrode 8, the second electrode 9, the electron source 10, and the upper electrode 26 are formed on the back-surface substrate 1. In the present embodiment, the second electrode 9 has different shapes on the edge that is conductive with the electron source 10 and on the edge that is not conductive, and the cross-sectional shape in the thickness direction is asymmetrical to the left and right of the center axis of the line. The conductive edge has a shape in which the second electrode 9 is tapered, the insulating film 14 is recessed by side etching in the non-conductive edge on the opposite side, and the second electrode 9 has the shape of eaves. This difference in edge shapes results in an element-separating structure in which in the conductive edge, the upper electrode 26 is formed continuously from the second electrode 9 to the electron source 10, whereas in the non-conductive edge portion, the upper electrode 26 is divided by the undercut 25 and is not conductive with adjacent electron sources.

In the embodiment described above, a structure using an MIM as an electron source was described as an example, but the present invention is not limited to this option alone and can also be similarly applied to a self-luminous FPD using the various electron sources previously described. Neodymium was given as an example for the aluminum alloy, but the present invention is not limited to this option alone, and various other examples can be used as necessary as the metals for the alloy.

While there have been described what are at present considered to be certain embodiments of the invention, it will be understood that various modifications may be made thereto, and it is intended that the appended claims cover all such modifications as fall within the true spirit and scope of the invention.

What is claimed is:

1. An image display device comprising:
a back-surface substrate having a plurality of first electrodes which extend in one direction and which are installed side by side in another direction perpendicular to this one direction, an insulating film formed so as to cover these first electrodes, a plurality of second electrodes which extend in the other direction on the insulating film and which are installed side by side in the one direction so as to cross the first electrodes, and an electron source which is provided in the vicinity of the intersecting parts of the first electrodes and second electrodes and which are connected with the second electrodes;
a front-surface substrate having a fluorescent layer provided in correspondence with the electron source, and further having an anode used for the application of an acceleration voltage so that electrons emitted from the electron source are directed toward the fluorescent layer;
a frame disposed between the front-surface substrate and the back-surface substrate so that the two substrates are maintained at a fixed spacing; and
a sealing member for sealing the frame and the two substrates in an airtight manner in a sealed area; wherein
the second electrodes cover the insulating film disposed beneath these second electrodes in at least the sealed area, and place the sealing members and the insulating film in a non-contact state.

2. The image display device according to claim 1, wherein the film width of the second electrodes in the direction perpendicular to the direction in which the second electrodes extend in the sealed area is in the following relationship with the film width of the insulating film in the same direction:
insulating film width <second electrode film width

3. The image display device according to claim 1, wherein at least the sealed-area parts of the second electrodes have a laminated film construction including a lower-layer film and an upper-layer film covering this lower-layer film, and the second electrodes are formed by the insulating film disposed beneath the lower-layer film being covered by the upper-layer film together with the lower-layer film in the sealed areas.

4. The image display device according to claim 3, wherein the second electrodes have a two-layer film structure in which the lower-layer film in the second electrodes is constructed from an aluminum film, and the upper-layer film is constructed from an aluminum alloy primarily composed of aluminum.

5. The image display device according to claim 3, wherein the second electrodes have a four-layer film structure in which the lower-layer film is formed with a three-layer film structure in which aluminum alloy films primarily composed of aluminum are disposed with the aluminum film sandwiched in between, and the upper-layer film is formed as the aluminum alloy film.

6. The image display device according to claim 3, wherein the thickness of the lower-layer film in the second electrodes is greater than the thickness of the upper-layer film.

7. The image display device according to claim 3, wherein the film width of the insulating film in the direction perpendicular to the direction of extension of the sealed area is in the following relationship with the film width of the other upper-layer film and the lower-layer film in the same direction:
Lower-layer film width <insulating film width <upper-layer film width.

8. A method for manufacturing an image display device comprising a back-surface substrate having a plurality of first electrodes which extend in one direction and which are installed side by side in another direction perpendicular to this one direction, an insulating film formed so as to cover these first electrodes, a plurality of second electrodes which extend in the other direction on the insulating film and which are installed side by side in the one direction so as to cross the first electrodes, and an electron source which is provided in the vicinity of the intersecting parts of the first electrodes and second electrodes, and which are connected with the second electrodes; a front-surface substrate which has a fluorescent layer provided in correspondence with the electron source, and further having an anode used for the application of an acceleration voltage so that the electrons emitted from the electron source are directed toward the fluorescent layer; a frame disposed between the front-surface substrate and the back-surface substrate so that the two substrates are maintained at a fixed spacing; and a sealing member for sealing the frame and the two substrates in an airtight manner in a sealed area, the method comprising the steps of:
forming first electrodes which are in the form of stripes and which have a tunnel insulating layer and a field insulating film on the surface of the back-surface substrate;
covering the surface of the substrate that includes the first electrodes by using the insulating film;
forming a stripe-form lower-layer film which constitutes a portion of the second electrodes and which is substantially perpendicular to the first electrodes on the insulating film using a first metal thin film;
forming a through-hole that reaches the field insulating film in a portion between the tunnel insulating layer of the insulating film and the lower-layer film;
removing the remaining part except for an area surrounded by the sealed area of the insulating films and an area beneath the lower-layer film of the exposed terminal part of the second electrodes;
covering a surface that includes the lower-layer film, an opening, and the like by using a second metal thin film;
working the second metal thin film to form an upper-layer film that continuously covers a side wall from an upper surface of the lower-layer film;
removing a portion of the insulating films beneath one of the side walls of the lower-layer films to form an undercut part beneath one of the side wall of the lower-layer films;
removing the insulating film laminated on the tunnel insulating layer of the first electrodes to expose the tunnel insulating layer;
forming an upper electrode film across the top of the second electrode from above the tunnel insulating layer; and
cutting the upper electrode film in the undercut part to perform element separation from the adjacent second electrode and forming an upper electrode on the second electrodes continuously from above the tunnel insulating layer.

9. The method for manufacturing an image display device according to claim 8, wherein the first metal is aluminum, and the second metal is an aluminum alloy primarily composed of aluminum.
